(19) United States
(12) Patent Application Publication
(10) Pub. No.: US 2011/0314190 A1
(43) Pub. Date: Dec. 22, 2011

(54) FIFO BUFFER SYSTEM

(75) Inventor: Tetsuya TANAKA, Kyoto (JP)

(73) Assignee: PANASONIC CORPORATION, Osaka (JP)

(21) Appl. No.: 13/222,757

(22) Filed: Aug. 31, 2011

Related U.S. Application Data
(63) Continuation of application No. PCT/JP2009/005411, filed on Oct. 16, 2009.

(30) Foreign Application Priority Data
Apr. 24, 2009 (JP) 2009-106381

(51) Int. Cl. G06F 3/00

(52) U.S. Cl. 710/52

(57) ABSTRACT

As a FIFO buffer system, a rewind function is realized without reducing a data transfer rate. Input data is written in a write FIFO buffer, and is packetized by a packetizing FIFO buffer to be written in a buffer memory area formed in a save memory. A multiplexer selects, in a first mode, an output of the write FIFO buffer, and in a second mode, packet data read from the buffer memory area. The multiplexer continuously selects the first mode until the read FIFO buffer becomes full.

### CROSS-REFERENCE TO RELATED APPLICATION

This is a continuation of PCT International Application PCT/JP2009/005411 filed on Oct. 16, 2009, which claims priority to Japanese Patent Application No. 2009-106381 filed on Apr. 24, 2009. The disclosures of these applications including the specifications, the drawings, and the claims are hereby incorporated by reference in their entirety.

### BACKGROUND

The present disclosure relates to FIFO buffer systems for temporarily storing received data, and outputting the data in the order in which the data was received.

As an example of conventional FIFO buffer systems, PCT International Publication No. WO 98/36534 (FIG. 4) shows a configuration in which an overflow area is provided in an external memory to perform a data save operation when there is no free space is left in a read buffer.

### SUMMARY

For recent applications, it is required to realize a rewind function in a FIFO buffer system. Rewind herein means re-reading of data, i.e., reading again of previous data, which has been already output, from the FIFO buffer system.

However, in the configuration of PCT International Publication No. WO 98/36534, data saved in the overflow area can be re-read from the external memory, but data, which has been directly output without being saved, cannot be re-read, since there is no data history for the data left in the external memory.

Therefore, to provide the FIFO buffer system with the rewind function, it is necessary to save all data in the external memory in preparation for re-reading. However, if the FIFO buffer system is configured so that all data is output via the external memory, a long time is required for data access to the external memory. Accordingly, a data transfer rate is reduced, and therefore, such a configuration is not preferable.

It is therefore an object of the present disclosure to realize the rewind function in a FIFO buffer system without reducing the data transfer rate.

According to one embodiment of the present disclosure, a FIFO buffer system which temporarily stores received data and outputs the data in an order in which the data was received includes a write FIFO buffer to which input data is written, a read FIFO buffer from which output data is read, a memory interface configured to manage a buffer memory area formed in a save memory, write packet data in the buffer memory area, and read packet data from the buffer memory area, a packetizing FIFO buffer configured to receive the input data in common with the write FIFO buffer, packetize the input data into packets having a predetermined packet size, and output the packetized input data as packet data to the memory interface, a multiplexer configured to select one of an output of the write FIFO buffer and the packet data output from the memory interface, and output the selected one to the read FIFO buffer, and a control section configured to control the FIFO buffer system, the control section controls a selection operation of the multiplexer to switch between a first mode in which the output of the write FIFO buffer is output to the read FIFO buffer and a second mode in which the packet data output from the memory interface is output to the read FIFO buffer, and in the first mode, when the read FIFO buffer becomes full, the control section switches the operation mode to the second mode, and in the second mode, when the buffer memory area becomes empty, the control section switches the operation mode to the first mode.

According to this embodiment, the input data is written in the write FIFO buffer, and is packetized by the packetizing FIFO buffer to be written in the buffer memory area formed in the save memory. That is, even in the first mode in which data is directly output from the write FIFO buffer to the read FIFO buffer, the input data is saved in the buffer memory area in the save memory. Thus, when a rewind request is made, data can be re-read from the save memory. Moreover, since data is directly output from the write FIFO buffer to the read FIFO buffer in the first mode until the read FIFO buffer becomes full, reduction in data transfer rate due to data saving is not caused.

According to the present disclosure, even input data which is output without passing through the save memory is saved in the buffer memory region of the save memory, and thus can be re-read without reducing the data transfer rate. Thus, a FIFO buffer system which has a rewind function and exhibits high data transfer rate can be realized.

### BRIEF DESCRIPTION OF THE DRAWINGS

FIG. 1 is a block diagram illustrating a configuration of a FIFO buffer system according to an embodiment.

FIG. 2 is a diagram describing a method for managing a buffer memory area.

FIG. 3 is a diagram describing a method for discarding history data in the buffer memory area.

FIG. 4 is a block diagram illustrating a configuration of a FIFO buffer system according to another embodiment.

### DETAILED DESCRIPTION

Embodiments of the present disclosure will be described in detail with reference to the accompanying drawings.

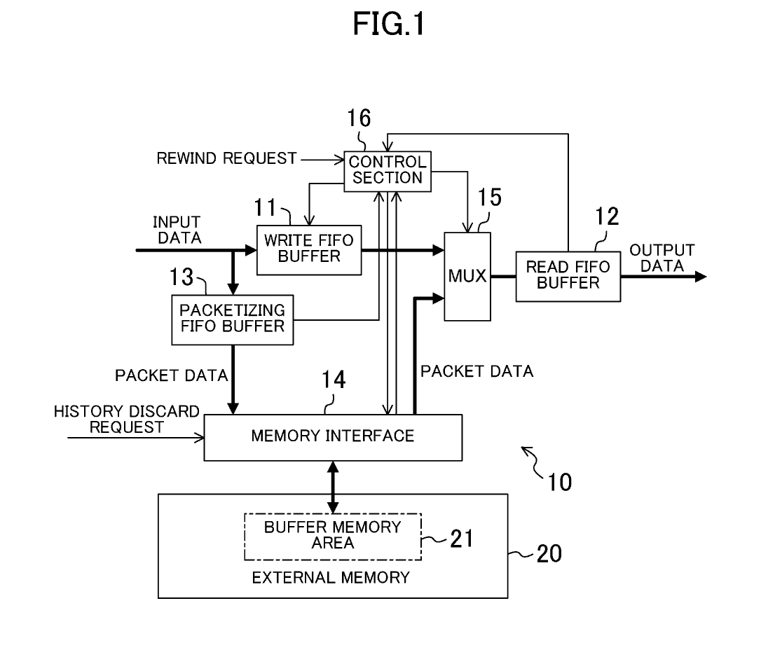

FIG. 1 is a block diagram illustrating a configuration of a FIFO buffer system according to an embodiment. The FIFO buffer system 10 of FIG. 1 temporarily stores received data, and outputs the data in the order in which the data was received. The FIFO buffer system 10 includes a write FIFO buffer 11, a read FIFO buffer 12, a packetizing FIFO buffer 13, a memory interface 14, a multiplexer 15, and a control section 16 configured to control the FIFO buffer system 10. The FIFO buffer system 10 is configured so that received data can be saved in a packet data format in an external memory 20 serving as a save memory.

The write FIFO buffer 11, a buffer for writing input data of the FIFO buffer system 10 sent from a write master, has a predetermined capacity and outputs the written input data in the order in which the input data was written. The read FIFO buffer 12, a buffer for reading output data of the FIFO buffer system 10 which is to be sent to a read master, has a predetermined capacity and outputs written data as the output data in the order in which the data was written. The memory interface 14 manages a buffer memory area 21 formed in the external memory 20, writes packet data in the buffer memory area 21 and reads packet data from the buffer memory area 21.

The packetizing FIFO buffer 13 receives input data of the FIFO buffer system 10 in common with the write FIFO buffer 11. That is, in the packetizing FIFO buffer 13, the same data is written as that in the write FIFO buffer 11. The packetizing FIFO buffer 13 packetizes the written data into packets having a predetermined packet size, and outputs obtained packet data to the memory interface 14. The memory interface 14 writes the packet data sent from the packetizing FIFO buffer 13 in the buffer memory area 21 of the external memory 20. The memory interface 14 also reads the packet data from the buffer memory area 21 of the external memory 20, and outputs the packet data to the multiplexer 15.

The multiplexer 15 selects one of an output of the write FIFO buffer 11 and packet data output from the memory interface 14, and outputs the selected one to the read FIFO buffer 12. The selection operation of the multiplexer 15 is controlled by the control section 16. Specifically, the control section 16 switches between a first mode in which the output of the write FIFO buffer 11 is output to the read FIFO buffer 12 via the multiplexer 15 and a second mode in which the packet data output from the memory interface 14 is output to the read FIFO buffer 12 via the multiplexer 15. In the first mode, data input to the FIFO buffer system 10 is directly output via the write FIFO buffer 11 and the read FIFO buffer 12. On the other hand, in the second mode, data input into the FIFO buffer system 10 is packetized to be temporarily stored in the buffer memory area 21, and then, is output via the read FIFO buffer 12.

In the first mode, when the read FIFO buffer 12 becomes full, the control section 16 switches the operation mode to the second mode. That is, when the read FIFO buffer 12 is almost overflowed while input data is directly output from the write FIFO buffer 11, outputting of the input data from the write FIFO buffer 11 is stopped. On the other hand, in the second mode, when the buffer memory area 21 becomes empty, the control section 16 switches the operation mode to the first mode. That is, when there is no more packet data which has been saved in the external memory 20 and has not been output yet, the operation is again set to the mode in which the input data is directly output from the write FIFO buffer 11.

In the configuration of this embodiment, input data of the FIFO buffer system 10 is written in the write FIFO buffer 11, and is packetized by the packetizing FIFO buffer 13 to be stored in the buffer memory area 21 of the external memory 20. That is, input data output directly from the write FIFO buffer 11 in the first mode is also saved as packet data in the buffer memory area 21. Thus, even the output data in the first mode can be re-read from the buffer memory area 21, when a rewind request is made. Moreover, while the read FIFO buffer 12 is not full, input data is directly output via the write FIFO buffer 11 in the first mode. Therefore, a problem such as interruption of data transfer due to packetization does not arise, and reduction in data transfer rate due to data saving is not caused, thus realizing smooth data transfer.

Note that in the second mode, when packet data is output from the packetizing FIFO buffer 13 to the memory interface 14, the control section 16 preferably discards data corresponding to the packet data from the write FIFO buffer 11. Thus, in the second mode, a problem can be avoided in which the write FIFO buffer 11 becomes full and input data cannot be received.

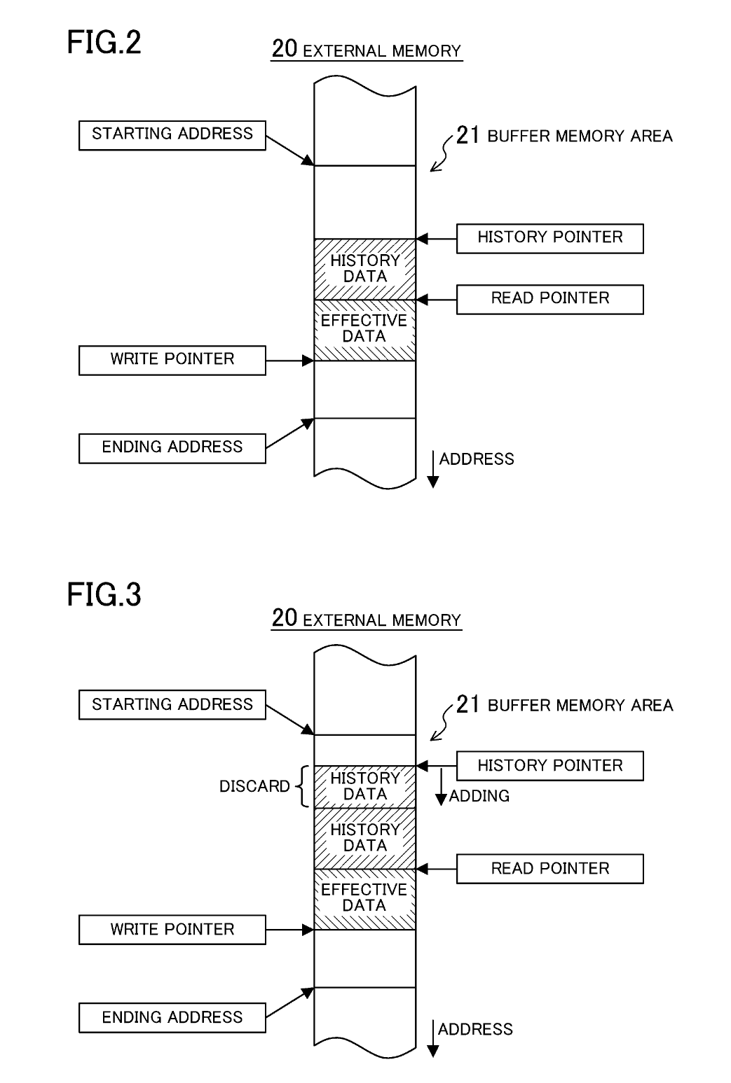

Next, a method for managing the buffer memory area 21 by the memory interface 14 will be described with reference to FIG. 2.

The buffer memory area 21 of the external memory 20 is managed by the memory interface 14. The memory interface 14 is configured to be capable of setting a starting address and an ending address of the buffer memory area 21 in order to manage the buffer memory area 21. For example, the memory interface 14 includes a register for storing the starting address and the ending address. The memory interface 14 further includes a write pointer indicating an address to which data is to be written next, a read pointer indicating an address from which data is to be read next, and a history pointer indicating a starting address of history data which has been already read (already-read history data).

When a data write operation is performed, a value corresponding to the size of write data is added to the write pointer. When a read operation is performed, a value corresponding to the size of read data is added to the read pointer. The history pointer has a role to protect already-read history data from being overwritten. Each of the write pointer, the read pointer, and the history pointer returns back to the starting address, when reaching the ending address of the buffer memory area 21.

Then, when the write pointer catches up with the history pointer, the buffer memory area 21 is full, and thus, no more data can be written therein. That is, the write pointer cannot move beyond the history pointer. Thus, data between the history pointer and the read pointer is protected as already-read history data. Also, when the read pointer catches up with the write pointer, the buffer memory area 21 is empty, and no more data can be read.

When a data rewind request is made, re-read of data is performed in the following manner. Specifically, when receiving a data rewind request, the control section 16 sets the operation mode to the second mode, and instructs the memory interface 14 on a re-read operation with specifying a re-read address. When the memory interface 14 is instructed on the re-read operation by the control section 16, it moves the read pointer back to the position of the specified re-read address. Thus, a part of already-read history data becomes effective, and can be re-read. However, the read pointer cannot be moved back beyond the history pointer.

When a history discard request is made, as shown in FIG. 3, the memory interface 14 moves the position of the history pointer forward by a predetermined address or the specified address. Thus, history data located above the position of the history pointer after moving is no longer protected, and is substantially discarded. However, the history pointer cannot be moved forward beyond the read pointer.

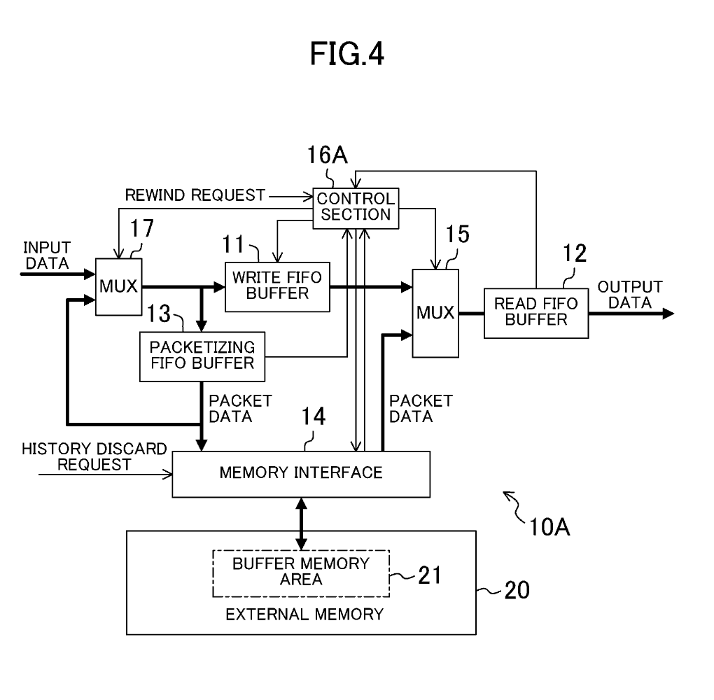

FIG. 4 is a block diagram illustrating a configuration of a FIFO buffer system according to another embodiment. In FIG. 4, each member also shown in FIG. 1 is identified by the same reference character, and the description thereof is omitted.

In a FIFO buffer system 10A of FIG. 4, a second multiplexer 17 is provided in a previous stage of the write FIFO buffer 11 and the packetizing FIFO buffer 13. The second multiplexer 17 selects, as data to be output to the write FIFO buffer 11 and the packetizing FIFO buffer 13 in common, one of input data and an output of the packetizing FIFO buffer 13. The selection operation of the second multiplexer 17 is controlled by a control section 16A.

In the configuration of FIG. 1, packet data which has been saved in the buffer memory area 21 can be rewound, but, if a rewind request is made for data which has not been packetized and remains in the packetizing FIFO buffer 13, it is difficult to immediately to perform rewind of the data. Therefore, in the configuration of FIG. 4, the second multiplexer 17 is provided to allow re-input of data of the packetizing FIFO buffer 13 to the write FIFO buffer 11. When receiving a rewind request, if data which needs to be re-read has not been packetized and remains in the packetizing FIFO buffer 13, the control section 16A controls the second multiplexer 17 to allow re-input of data in the packetizing FIFO buffer 13 to the write FIFO buffer 11. Thus, data remaining in the packetizing FIFO buffer 13 can be also processed in response to a rewind request.

According to the present disclosure, a FIFO buffer system which has a rewind function and exhibits high data transfer rate can be realized. Therefore, for example, in decoding image data coded using variable-length coding in a video system, when a plurality of sets of coded data are switched around to be input in a single decoding apparatus, such a FIFO buffer system is effectively used to discard read-ahead coded data and re-read the coded data in a subsequent processing.

What is claimed is:

1. A FIFO buffer system which temporarily stores received data and outputs the data in an order in which the data was received, the FIFO buffer system comprising:
a write FIFO buffer to which input data is written;
a read FIFO buffer from which output data is read;
a memory interface configured to manage a buffer memory area formed in a save memory, write packet data in the buffer memory area, and read packet data from the buffer memory area;
a packetizing FIFO buffer configured to receive the input data in common with the write FIFO buffer, packetize the input data into packets having a predetermined packet size, and output the packetized input data as packet data to the memory interface;
a multiplexer configured to select one of an output of the write FIFO buffer and the packet data output from the memory interface, and output the selected one to the read FIFO buffer; and
a control section configured to control the FIFO buffer system,
wherein
the control section controls a selection operation of the multiplexer to switch between a first mode in which the output of the write FIFO buffer is output to the read FIFO buffer and a second mode in which the packet data output from the memory interface is output to the read FIFO buffer, and
in the first mode, when the read FIFO buffer becomes full, the control section switches the operation mode to the second mode, and in the second mode, when the buffer memory area becomes empty, the control section switches the operation mode to the first mode.

2. The FIFO buffer system of claim 1, wherein
in the second mode, when the packet data is output from the packetizing FIFO buffer to the memory interface, the control section discards data corresponding to the packet data from the write FIFO buffer.

3. The FIFO buffer system of claim 1, wherein
the memory interface is configured to be capable of setting a starting address and an ending address of the buffer memory area, and includes a write pointer indicating an address to which data is to be written next, a read pointer indicating an address from which data is to be read next, and a history pointer indicating a starting address of history data which has been already read, and
when the read pointer catches up with the write pointer, the buffer memory area is empty, and when the write pointer catches up with the history pointer, the buffer memory area is full.

4. The FIFO buffer system of claim 3, wherein
when receiving a rewind request, the control section sets the operation mode to the second mode, and instructs the memory interface on a re-read operation with specifying a re-read address, and
when being instructed on the re-read operation by the control section, the memory interface moves the read pointer back to a position of the specified re-read address, and reads packet data.

5. The FIFO buffer system of claim 3, wherein
when receiving a history discard request, the memory interface moves a position of the history pointer forward by a predetermined address or a specified address.

6. The FIFO buffer system of claim 1, further comprising:
a second multiplexer configured to select one of the input data and an output of the packetizing FIFO buffer, and output the selected one to the write FIFO buffer and the packetizing FIFO buffer in common,
wherein
when receiving a rewind request, if data in the packetizing FIFO buffer needs to be re-read, the control section controls the second multiplexer so that the output of the packetizing FIFO buffer is output to the write FIFO buffer and the packetizing FIFO buffer in common.
